(19) United States
(12) Patent Application Publication
(10) Pub. No.: US 2018/0322980 A1
(43) Pub. Date: Nov. 8, 2018

(54) Surface Treating Magnet Wire Enamel Layers To Promote Layer Adhesion

(71) Applicant: Essex Group, Inc., Atlanta, GA (US)

(72) Inventors: Matthew Leach, Fort Wayne, IN (US); Allan R. Knerr, Fort Wayne, IN (US)

(21) Appl. No.: 15/966,736

(22) Filed: Apr. 30, 2018

Related U.S. Application Data
(60) Provisional application No. 62/501,785, filed on May 5, 2017.

(51) Int. Cl. H01B 3/30; H01B 3/08; H01B 7/29

(52) U.S. Cl. CPC H01B 3/30; H01B 7/292; H01B 3/081

(57) ABSTRACT

A method for forming an insulated winding wire with enhanced adhesion between enamel layers is described. A conductor may be provided, and a first enamel layer may be formed around the conductor. The first enamel layer may include a first thermoset polymeric material. An outer surface of the first enamel layer maybe modified, for example, by a plasma, corona, ultraviolet, or flame treatment. The surface modification may alter a surface energy of the first enamel layer. A second enamel layer may be formed on the first enamel layer, and the second enamel layer may include a second thermoset polymeric material.

### CROSS-REFERENCE TO RELATED APPLICATION

This application claims priority to U.S. Provisional Application No. 62/501,785, filed May 5, 2017 and entitled “Plasma Treating Magnet Wire Enamel Layers to Promote Layer Adhesion,” the contents of which is incorporated by reference herein in its entirety.

### TECHNICAL FIELD

Embodiments of the disclosure relate generally to insulated, winding wire and, more particularly, to insulated winding wire in which one or more enamel layers are surface treated in order to promote layer adhesion.

### BACKGROUND

Magnetic winding wire, also referred to as magnet wire or insulated winding wire, is used in a multitude of devices that require the development of electrical and/or magnetic fields to perform electromechanical work. Examples of such devices include electric motors, generators, transformers, actuator coils, etc. Typically, magnet wire is constructed by applying electrical insulation to a metallic conductor, such as a copper, aluminum, or alloy conductor. The electrical insulation is typically formed as a coating that provides for electrical integrity and prevents shorts in the magnet wire. Conventional insulation is often formed from a combination of polymeric enamel films. Typically, each enamel layer is applied as a varnish that is cured in an enameling oven. A plurality of layers are successively formed on one another until a desired enamel thickness or build is attained.

When a plurality of enamel layers are formed, there is a possibility that inter layer delamination can occur. For example, two successive enamel, layers may separate from one another. Similarly, an innermost enamel layer may separate from a conductor. The chances of inter layer delamination may be higher for certain types of polymeric enamels, such as polyimide enamels. Accordingly, an opportunity exists for improved insulated winding wire having enhanced inter layer adhesion. Additionally, an opportunity exists for improved systems and methods for forming insulated winding wire having enhanced inter layer adhesion.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items; however, various embodiments may utilize elements and/or components other than those illustrated in the figures. Additionally, the drawings are provided to illustrate example embodiments described herein and are not intended to limit the scope of the disclosure.

FIGS. 1A-1B are cross-sectional views of example magnet wire constructions that include a plurality of enamel layers, according to illustrative embodiments of the disclosure.

FIG. 2 illustrates a schematic diagram of an example system that may be utilized to form insulation on magnet wire, according to an illustrative embodiment of the disclosure.

FIG. 3 illustrates a flow chart of an example method for forming magnet wire, according to an illustrative embodiment of the disclosure.

### DETAILED DESCRIPTION

Various embodiments of the present disclosure are directed to insulated winding wires, magnetic winding wires, and/or magnet wires (hereinafter referred to as “magnet wire”) that include a conductor and/or one or more enamel layers having modified, surfaces that promote inter layer adhesion. Other embodiments are directed to systems and methods for forming magnet wire and/or magnet wire insulation having one or more enamel layers with modified surfaces that promote inter layer adhesion. In certain embodiments, a magnet wire may include a conductor and a plurality of enamel layers successively formed around the conductor. Additionally, at least one enamel layer may have an outer surface that is modified by a suitable treatment, such as plasma, gas flame, corona, and/or ultraviolet (“UV”) treatment, in order to promote adhesion between the enamel layer and a layer (e.g., another enamel layer) formed on top of the enamel layer. Similarly, in certain embodiments, an outer surface of the conductor may be modified by a suitable treatment, such as plasma, gas flame, corona, and/or UV treatment, in order to promote adhesion between the conductor and a first or innermost enamel layer.

A wide variety of suitable methods and/or techniques may be utilized to modify the outer surface of an enamel layer and/or a magnet wire conductor. For example, in certain embodiments, a plasma unit or other suitable device may be utilized to bombard an outer surface of an enamel layer (or conductor) with plasma. Plasma may be an ionized gas capable of conducting electricity and absorbing energy from an electrical supply. In certain embodiments, a plasma gas may be produced by inducing an electrical charge in a suitable gas, such as oxygen, nitrogen, helium, ammonia, argon or others. Similar units and/or devices maybe utilized to modify an outer surface with a corona, gas flame, or UV treatment. When plasma or another suitable treatment is utilized to modify an outer surface of an enamel or other layer, the treatment may alter the topography of the surface and/or impart roughness on the surface. In certain embodiments, the treatment may also functionalize the surface by causing the formation of one or more functional groups on the surface. The altered topography and/or functional groups may enhance or promote bonding of a layer (e.g., an enamel layer, etc.) that is subsequently formed on the modified surface. Additionally, the altered topography may modify the surface energy of an enamel or other layer. thereby allowing a subsequently formed enamel layer to spread more evenly when applied. In other words, the altered topography may enhance the wettability of a subsequently formed enamel layer, thereby facilitating easier application and/or improved concentricity. In certain embodiments, the plasma or other treatment may also clean the outer surface of a treated layer and/or remove debris from the outer surface.

Embodiments of the disclosure now will be described more fully hereinafter with reference to the accompanying drawings, in which certain embodiments of the disclosure are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

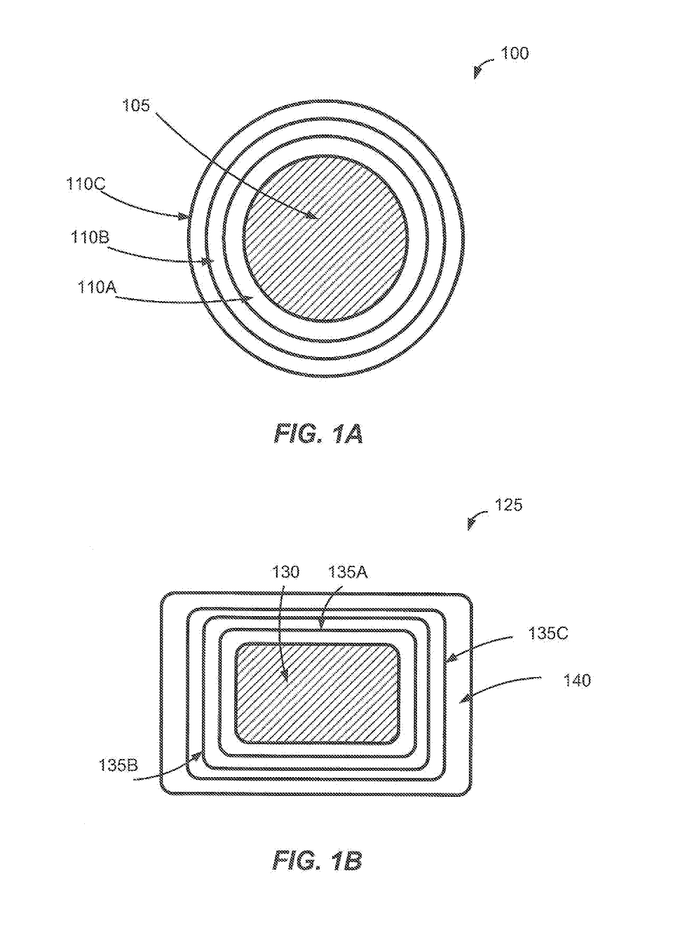

FIGS. 1A and 1B illustrate cross-sectional views of example magnet wire constructions that maybe formed in accordance with various embodiments of the disclosure. FIG. 1A illustrates an example magnet wire 100 having a round or circular cross-sectional shape. FIG. 1B illustrates an example magnet wire 125 having a rectangular cross-sectional shape. Other suitable cross-sectional shapes may be utilized as desired in various embodiments, and those depicted are provided by way of non-limiting example only. Each of the example magnet wires 100, 125 may be formed with a wide variety of suitable dimensions. Additionally, as explained in greater detail below, each of the example magnet wires 100, 125 may include a respective conductor with insulation formed around the conductor.

With reference to FIG. 1A, a cross-sectional view of a first example magnet wire 100 is illustrated. The magnet wire 100 may include a central conductor 105 and a plurality of enamel layers 110A-C formed as insulation around the central conductor 105. As desired, a wide variety of other insulation layers may optionally be formed around the conductor 105 including, but not limited to, one or more semi-conductive layers, one or more extruded layers (e.g., an extruded layer formed around an outermost enamel layer 110C, etc.), and/or one or more conformal layers (e.g., an outermost layer formed from a parylene material, etc.).

Similarly, with reference to FIG. 1B, a second example magnet wire 125 may include a central conductor 130 and a plurality of enamel layers 135A-C formed as insulation around the central conductor 130. As desired, a wide variety of other insulation layers may optionally be formed around the conductor 125 as described above for the first example magnet wire 100. For example, an extruded layer 140 may be formed around an outermost enamel layer 135C. The first example magnet wire 100 is generally described in greater detail below; however, it will be appreciated that the description is equally applicable to the second example magnet wire 125 and/or to a wide variety of other suitable magnet wires (e.g., magnet wires having other cross-sectional shapes, etc.).

The conductor 105 may be formed from a wide, variety of suitable materials or combinations of materials. For example, the conductor 105 may be formed from copper, aluminum, annealed copper, oxygen-free copper, silver-plated copper, nickel plated copper, copper clad aluminum (“CCA”), silver, gold, a conductive alloy, a bimetal, or any other suitable electrically conductive material. Additionally, the conductor 105 may be formed with any suitable dimensions and/or cross-sectional shapes. As shown in FIG. 1A, the conductor 105 may have an approximately circular or round cross-sectional shape. However, as shown in FIG. 1B, a conductor 125 may have a rectangular or approximately rectangular cross-sectional shape. In other embodiments, a conductor may be formed with a square shape, an elliptical or oval shape, or any other suitable cross-sectional shape. Additionally, as desired for certain cross-sectional shapes such as a rectangular cross-sectional shape, a conductor may have comers that are rounded, sharp, smoothed, curved, angled, truncated, or otherwise formed.

In addition, the conductor 105 may be formed with any suitable dimensions. An example round conductor may have a diameter between approximately 0.010 inches (254 μm) and approximately 0.500 inches (127.00 μm). An example rectangular conductor may have longer sides between approximately 0.020 inches (508 μm) and approximately 0.750 inches (19050 μm) and shorter sides between approximately 0.020 inches (508 μm) and approximately 0.400 inches (10160 μm). An example square conductor may have sides between approximately 0.020 inches (508 μm) and approximately 0.500 inches (12700 μm). Other suitable dimensions may be utilized as desired, and the described dimensions are provided by way of non-limiting example only.

A wide variety of suitable methods and/or techniques may he utilized to form, produce, or otherwise provide a conductor 105. In certain embodiments, a conductor 105 may be formed by drawing an input material (e.g., a larger conductor, rod stock, etc.) with one or more dies in order to reduce the size of the input material to desired dimensions. As desired, one or more flatteners and/or rollers may be used to modify the cross-sectional shape of the input material before and/or after drawing the input material through any of the dies. In other embodiments, a conductor 105 may be formed via a continuous extrusion process. Other conductor formation techniques may be utilized as desired, such as additive manufacturing, etc. Additionally, in certain embodiments, the conductor 105 may be formed in tandem with the application of a portion or all of the insulation system. In other words, conductor formation and application of insulation material (e.g., a plurality of enamel layers 110A-C, etc.) may he conducted in tandem. In other embodiments, a conductor 105 with desired dimensions may be preformed or obtained from an external source. Insulation material may then be formed around the conductor 105.

With continued reference to FIG. 1A, a plurality of layers of enamel 110A-C may be formed around the conductor 105. An enamel layer (generally referred to as layer 110) is typically formed by applying a polymeric varnish to the conductor 105 and then baking the conductor 105 in a suitable enameling oven or furnace. The polymeric varnish typically includes polymeric material suspended in one or more solvents. Following application of the varnish, solvent is removed as a result of baking or curing, thereby leaving a solid polymeric enamel layer. In certain embodiments, a plurality of layers of enamel 110A-C may be applied to the conductor 105 in order to achieve a desired enamel thickness or build. Each enamel layer may be formed utilizing a similar process. In other words, a first enamel layer may be formed, for example, by applying a suitable varnish and passing the conductor through an enameling oven. A second enamel layer may subsequently be formed by applying a suitable varnish and passing the conductor through either the same enameling oven or a different enameling oven. Indeed, an enameling oven may be configured to facilitate wires making multiple passes through the oven. As desired in various embodiments, other curing devices may be utilized in addition to or as an alternative to one or more enameling ovens. For example, one or more suitable infrared light and/or ultraviolet light curing systems may be utilized.

Although three enamel layers are illustrated in FIG. 1A, any number of enamel layers may be formed as desired in various embodiments. Additionally, each layer of enamel and/or a total enamel build may have any desired thickness, such as a thickness of approximately 0.0002, 0.0005, 0.007, 0.001, 0.002, 0.003, 0.004, 0.005, 0.006, 0.007, 0.008, 0.009, 0.010, 0.012, 0.015, 0.017, or 0.020 inches, a thickness included in a range between any two of the aforementioned values, and/or a thickness included in a range bounded on either a minimum or maximum end by one of the aforementioned values.

A wide variety of different types of polymeric materials may be utilized as desired to form an enamel layer 110. Examples of suitable materials include, but are not limited to, polyimide, polyamideimide, amideimide, polyester, polyesterimide, polysulfone, polyphenylenesulfone, polysulfide, polyphenylenesulfide, polyetherimide, polyamide, polyketones, etc. In certain embodiments, enamels may include polymeric materials that are thermoset materials rather than thermoplastic materials. For purposes of this disclosure, a thermoset material may be a material that is generally non-meltable. A thermoset material may degrade or decompose before it melts, thereby preventing the material from being melted and reformed. As a result, thermoset materials are typically applied in a varnish and subsequently cured in order to form, polymeric insulation. By contrast, a thermoplastic material may typically be melted and reformed without, degradation or deterioration. Thermoplastic materials are typically melted and extruded, in order to form insulation.

In certain embodiments, enamel materials having relatively low dielectric constants “ε”, such as dielectric, constants below approximately 3.5 at approximately 25° C., may be utilized in order to improve electrical performance. Irv certain embodiments, enamel materials having relatively low permittivity, such as a permittivity below approximately 2.5, 3, 3.0, 3.5, 4.0, or 4.5 may be utilized. As desired, enamel materials may be selected to have a suitable. National Electrical Manufacturers Association (“NEMA”) thermal class or thermal rating, such as a rating of A, B, F, H, N, R, S, or higher. Higher temperature enamel materials may having a NEMA thermal class rating of R, S, or higher. Additionally, in certain embodiments, an enamel layer 110 may be formed as a mixture of two or more materials. Further, in certain embodiments, different enamel layers may be formed from the same materials) or from different materials. For example, a first enamel layer 110A may be formed from a polyimide material and a second enamel layer 110B may be formed from a polyamideimide material. A wide variety of suitable combinations of different types of polymeric materials may be utilized to form a plurality of enamel layers.

In certain embodiments, one or more suitable filler materials and/or additives may be incorporated into an enamel layer 110. Examples of suitable filler materials include, but are not limited to, inorganic materials such as metals, transition metals, lanthanides, actinides, metal oxides, and/or hydrated oxides of suitable materials such as aluminum, tin, boron, germanium, gallium, lead, silicon, titanium, chromium, zinc, yttrium, vanadium, zirconium, nickel, etc.; suitable organic materials such as polyaniline, polyacetylene, polyphenylene, polypyrrol, other electrically conductive particles; and/or any suitable combination of materials. The filler material(s) may enhance the corona resistance of the enamel and/or the overall insulation system. In certain embodiments, the filler material(s) may also enhance one or more thermal properties of the enamel and/or overall insulation system, such as temperature resistance, cut-through resistance, and/or heat shock. The particles of a filler material may have any suitable dimensions, such as any suitable diameters. In certain embodiments, a filler material may include nanoparticles. Further, any suitable blend or mixture ratio between filler material and enamel base material may be utilized.

According to an aspect of the disclosure, at least one enamel layer 110 may have an outer surface that is modified by a plasma, corona, flame, ultraviolet (“UV”) or other suitable treatment in order to promote adhesion between the enamel layer and a layer formed on top of the enamel layer and/or to enhance the wettability of a varnish used to form a layer on top of the enamel layer. In one example embodiment, a first enamel layer 110A may be modified by a suitable treatment prior to formation of a second enamel layer 110B around the first enamel layer 110A. The modification of the first enamel layer 110A by a suitable treatment may facilitate a stronger bond and/or improved adhesion between the first enamel layer 110A and the second enamel layer 110B. As a result, the possibility of inter layer delamination may be reduced. The surface modification of the first enamel layer 110A may also improve the wettability of a varnish used to form the second enamel layer 110B. For example, the surface modification may alter the surface energy of the first enamel layer 110A, thereby allowing the varnish to more evenly spread along a surface of the first enamel layer 110A. In other words, pooling of the varnish on the surface of the first enamel layer 110A may be reduced as a result of the surface modification. Improved wettability and/or varnish flow during the formation of an enamel layer may assist in improving the concentricity of the formed enamel layer. The concentricity of the enamel layer may be the ratio of the thickness of an enamel layer to the thinness of the layer at any given cross-sectional along a longitudinal length of the magnet wire 100. As desired in various embodiments, any number of enamel layers may be modified by a suitable plasma or other treatment. For example, in certain embodiments, each respective enamel layer may be modified prior to formation of a next enamel layer. In one example embodiment, each time the wire 100 exits an enameling oven used to cure an enamel layer, the cured enamel layer may be modified by a plasma unit or other suitable device prior to application of a varnish for formation of a next enamel layer. In other embodiments, only a portion of the enamel layers may be modified.

Additionally, in certain embodiments, an outer surface of the conductor 105 may be modified by a plasma treatment or other suitable treatment in order to promote adhesion between the conductor 105 and a first or innermost enamel layer, such as enamel layer 110A. For example, an outer surface of the conductor 105 may be modified by a plasma unit or other suitable system prior to application of a varnish for formation of an innermost enamel layer around the conductor 105. The modification of the conductor 105 may also improve the wettability of the innermost enamel layer and/or may improve the concentricity of the innermost enamel layer. In certain embodiments, one or more additional layers may be formed over the plurality of enamel layers 110A-C. For example, as shown in FIG. 1B, an extruded thermoplastic layer may be formed around a plurality of enamel layers 110A-C. As desired, a top or outermost enamel layer 110C may be modified by a plasma treatment or other suitable treatment in order to promote adhesion between the outermost enamel layer 110C and an extruded thermoplastic layer or other layer formed around the outermost enamel layer 110C.

A surface modification treatment, such as a plasma, corona, gas flame, or UV treatment, may promote adhesion between a wide variety of different types of enamel layers. The enamel layers may include a Wide variety of suitable polymeric materials. In certain embodiments, the enamel layers may include thermoset materials. For example, a suitable surface treatment may promote adhesion, between adjacent layers of polyimide (“PI”) enamel. As another example, a suitable surface treatment may promote adhesion between layers of polyamideimide (“PAI”); amideimide, polyester, polyesterimide, polysulfone, polyphenylenesulfone, polysulfide, polyphenylenesulfide, polyetherimide, polyamide, or other types of enamel. As another example, a suitable surface treatment may promote adhesion between two enamel layers formed from different materials.

A wide variety of suitable methods and/or techniques may be utilized to modify the outer surface of an enamel layer 110 and/or the conductor 105. For example, in certain embodiments, a plasma treatment may be utilized to modify the outer surface of an enamel or other layer. A wide variety of suitable plasma treatments may be utilized as desired, such as atmospheric plasma, vacuum plasma, corona plasma, and/or plasma flame treatment. In certain embodiments, a plasma unit, plasma torch, or other suitable device may be utilized to bombard an outer surface of an enamel layer 110 (or conductor 105) with plasma. Plasma may be an ionized gas capable of conducting electricity and absorbing energy from au electrical supply. In certain embodiments, a plasma gas may be produced by inducing an electrical charge in a suitable gas, such as oxygen, nitrogen, helium, ammonia, or argon. In other embodiments, a corona treatment may be utilized to modify the outer surface of an enamel or other layer. For example, one or more suitable corona discharge apparatuses maybe utilized to bombard an outer surface of a layer. A corona discharge may be an electrical discharge brought on by the ionization of a fluid (e.g., air) surrounding an electrically charged conductor. In yet other embodiments, a gas flame treatment may be utilized to modify the outer surface of an enamel or other layer. For example, one or more suitable gas flame torches or other suitable devices may be utilized to bombard or otherwise impact an outer surface of a layer. In yet other embodiments, a UV treatment may be utilized to modify the outer surface of an enamel or other layer. For example, one or more UV irradiation apparatuses may be utilized to bombard or otherwise impact an outer surface of a layer. Other suitable surface modification techniques, devices, and/or systems may be utilized as desired.

When a suitable treatment is utilized to modify an outer surface of an enamel or other layer, the treatment may alter the topography of the surface and/or impart roughness on the surface. In certain embodiments, the treatment may also functionalize the surface by causing the formation of one or more functional groups on the surface. A wide variety of different types of functional groups maybe formed in various embodiments including, but not limited to, a carboxyl group, an ester group, an amine group, an ether group, or a hydroxyl group. In certain embodiments, the type of functional group that is formed may he based at least in part upon the atmospheric conditions associated with the treatment. For example, if a plasma treatment is performed in air, then one or more carboxyl groups maybe formed. As another example, if ammonia is introduced into a plasma process, then one or more amine groups may be formed.

The altered topography and/or functional groups may enhance or promote bonding of a layer (e.g., an enamel layer, etc.) that is subsequently formed on the modified surface. In other words, interlayer adhesion may be promoted. As a result of the enhanced adhesion, the likelihood of interlayer delamination may be reduced. In certain embodiments, the enhanced adhesion may also facilitate the formation of relatively thicker enamel builds. With conventional enamel formation and processing techniques, enamel may be prone to separation from a conductor once an overall build exceeds a threshold. By enhancing adhesion between the conductor and enamel and/or the various enamel layers, if may be possible to achieve an overall build that is greater than conventional builds.

Additionally, in certain embodiments, the altered topography may enhance or improve the wettability of a varnish utilized to form a subsequent enamel layer. For example, the altered topography may result in altering the surface energy of a treated layer, thereby allowing a subsequently applied varnish to more evenly spread along a surface of the treated layer. In other words, pooling of the varnish on the surface of an underlying treated layer may be reduced and the wettability of the applied varnish may be increased. The contact angle of the applied varnish layer may also be reduced. A wide variety of surface energy modifications may be attained in various embodiments as a result of a surface treatment. In certain embodiments, the surface energy may be increased by approximately 20, 25, 30, 35, 40, 45, 50, 55, 60, 65, 70, or 75 mN/m (“dynes per centimeter”), by an amount included in a range between any two of the above values (e.g., by approximately 20 to approximately 75 mN/m, etc.), or by an amount included in a range bounded on a minimum end by one of the above values. In certain embodiments, improved wettability and/or varnish flow during the formation of an enamel layer (i.e., an enamel layer formed on a layer that has been modified with a surface treatment) may assist in improving the concentricity of the formed enamel layer. The concentricity of the enamel layer may be the ratio of the thickness of an enamel layer to the thinness of the layer at any given cross-sectional along a longitudinal length, of the magnet wire 100. Further, in certain embodiments, the surface treatment may also clean the outer surface of a treated layer and/or remove debris from the outer surface.

As desired in certain embodiments, one or more other layers of insulation may be incorporated into a magnet wire 100 in addition to a plurality of enamel layers 105A-C. For example, one or more extruded thermoplastic layers, semi-conductive layers, tape insulation layers, and/or conformal coatings may be incorporated into a magnet wire 100. FIG. 1B illustrates an example magnet wire 125 in which an extruded thermoplastic layer 140 is formed around a plurality of enamel layers 135A-C. A wide variety of other insulation configurations and/or layer combinations may be utilized as desired. Additionally, an overall insulation system may include any number of suitable sublayers formed from any suitable materials and/or combinations of materials. A few example types of insulation that may be combined with enamel layers are described in greater detail below.

In certain embodiments, one or more suitable wraps or tapes, such as a polymeric tape, may be wrapped around a plurality of enamel layers 105A-C. As desired, additional materials or additives may be incorporated into, embedded into, or adhered to a tape. A tape may include a wide variety of suitable dimensions, such as any suitable thickness and/or width. Additionally, a tape may be wrapped around the conductor 105 at an angle along a longitudinal direction or length of the conductor 105.

In other embodiments, one or more layers of extruded material, such as extruded layer 140 illustrated in FIG. 1B, may be incorporated into an insulation system. In certain embodiments, an extruded layer 140 may be formed from a suitable thermoplastic resin. A wide variety of suitable materials may be incorporated into a resin or into a plurality of resins that are utilized to form extruded layers. Examples of suitable materials include, but are not limited to, polyether-ether-ketone (“PEEK”), polyaryletherketone (“PAEK”), polyetheretherketoneketone (“PEEKK”), polyetherketoneketone (“PEKK”), polyetherketone (“PEK”), polyetherketoneketoneetherketone (“PEKKEK”), polyketone (“PK”), any other suitable material that includes at least one ketone group, thermoplastic polyimide (“PI”), aromatic polyamide, aromatic polyester, polyphenylene sulfide (“PPS”), materials that combine one or more fluoropolymers with base materials (e.g., materials that include at least one ketone group, etc.), any suitable-thermoplastic material, etc. In certain embodiments, a single extruded layer may be formed. In other embodiments, a plurality of extruded layers may be formed. If a plurality of layers is utilized, the extruded layers may be formed from the same material or, alternatively, at least two layers may be formed from different materials.

An extruded layer 140 may be formed with any suitable thickness as desired in various embodiments. For example, an extruded layer may be formed with a thickness of approximately 0.001, 0.002, 0.003, 0.004, 0.005, 0.006, 0.007, 0.008, 0.009, 0.010, 0.012, 0.015, 0.017, 0.020, 0.022, or 0.024 inches, a thickness included in a range between any two of the aforementioned values, or a thickness included in a range bounded on either a minimum or maximum end by one of the aforementioned values. In certain embodiments, an extruded layer 140 may be formed directly on an underlying layer (e.g., an outermost enamel layer, etc.). For example, the temperature of the magnet wire 100 may be controlled prior to the application of an extruded layer 140 to eliminate the need for an adhesive layer. In other embodiments, one or more suitable bonding agents, adhesion promoters, or adhesive layers may be incorporated between the extruded layer and an underlying layer. Additionally, in certain embodiments, the extruded layer 140 may be formed to have a cross-sectional shape similar to that of the underlying conductor and/or any underlying insulation layers. In other embodiments, an extruded layer 140 may be formed with a cross-sectional shape that varies from that of the underlying conductor. As one non-limiting example, the conductor may be formed with an elliptical cross-sectional shape while an extruded layer is formed with an approximately rectangular cross-sectional shape.

In certain embodiments, one or more semi-conductive layers may be incorporated into the magnet wire 100. For example, one or more semi-conductive layers may be formed on the conductor 105 and/or incorporated into a plurality of enamel layers 105A-C. A semi-conductive layer may have a conductivity between that of a conductor and that of an insulator. Typically, a semi-conductive layer has a volume conductivity (σ) between approximately 10⁻⁸ Siemens per centimeter (S/cm) and approximately 10³ S/cm at approximately 20 degrees Celsius (° C.). A semi-conductive layer maybe formed from a wide variety of suitable materials and/or combinations of materials. For example, one or more suitable semi-conductive enamels, extruded semi-conductive materials, semi-conductive tapes, and/or semi-conductive wraps may be utilized. In certain embodiments, a semi-conductive layer may be formed from a material that combines one or more suitable filler materials with one or more base materials. For example, semi-conductive and/or conductive filler material may be combined with one or more base materials. Examples of suitable filler materials include, but are not limited to, suitable inorganic materials such as metallic materials and/or metal oxides (e.g., zinc, copper, aluminum, nickel, tin oxide, chromium, potassium titanate, etc.), and/or carbon black; suitable organic materials such as polyaniline, polyacetylene, polyphenylene, polypyrrole, other electrically conductive particles; and/or any suitable combination of materials. The particles of the filler material may have any suitable dimensions, such as any suitable diameters. In certain embodiments, the filler material may include nanoparticles. Examples of suitable base materials may include, but are not limited to, polyimide, polyamideimide, amideimide, polyester, polyesterimide, polysulfone, polyphenylenesulfone, polysulfide, polyphenylenesulfide, polyetherimide, polyamide, or any other suitably stable high temperature thermoplastic or other material. Further, any suitable blend or mixture ratio between filler material and base material may be utilized.

Additionally, a semi-conductive layer may have any suitable thickness. For example, one or more semi-conductive layers may have thicknesses similar to those discussed above for enamel layers. In certain embodiments, one or more semi-conductive layers may be formed in a similar manner as an enamel layer. For example, a varnish including semi-conductive material may be applied, and the varnish may be heated by one or more suitable heating devices, such as an enameling oven. In other embodiments, one or more semi-conductive layers may be extruded. As a result of incorporating one or more semi-conductive layers into the magnet wire 100, non-uniform electric, magnetic, and/or electromagnetic fields (hereinafter collectively referred to as electric fields) may be equalized or “smoothed out” thereby reducing local stress in the insulation and improving electrical performance. In other words, one or more semi-conductive layers may assist in equalizing voltage stresses in the insulation and/or dissipating corona discharges at or near the conductor 105 and/or at or near a surface of the magnet wire 100.

Regardless of the number and/or types of insulation layers formed on a magnet wire 100, the insulation (and/or any sublayers) may he formed with any desired concentricity. In certain embodiments the insulation and/or any sublayer may be formed with a concentricity less than or equal to approximately 1.1, 1.2, 1.3, 1.4, 1.5, or any other suitable value. Additionally, regardless of the number of sublayers incorporated into the insulation, the insulation may have any desired overall thickness. As desired, the insulation may be formed from one or more layers that have any number of desirable properties, such as desired PDIV, dielectric strength, dielectric constant, and/or thermal rating values. For example, the insulation may have a thermal rating of 180° C., 200° C., 220° C., 240° C., or higher.

In certain embodiments, one or more conformal layers may be formed as outermost layers of a magnet wire 100. For example, one or more layers containing parylene (or another suitable conformal material) may be formed around the conductor 105 and any other insulation layers, such as the plurality of enamel layers 110A-C. As desired, an adhesion promoter may optionally be applied to an underlying layer prior to the formation of a conformal layer. Additionally, as desired, an underlying layers may be subjected to a plasma treatment prior to formation of a conformal layer. In certain embodiments, a single conformal layer may be formed. In other embodiments, two or more, conformal layers may be formed. Each conformal coating) may consist of a relatively thin polymeric film that conforms to the contours of an underlying winding or magnet wire, article formed from a magnet wire, or an appliance incorporating a magnet wire. Additionally, a conformal coating may be applied utilizing a wide variety of techniques. For example, a conformal coating may be applied via one or more suitable chemical vapor deposition techniques. In other embodiments a conformal coating may be applied via brushing, dipping, spraying, and or other suitable methods. Certain embodiments of the disclosure described herein discuss conformal coatings that include parylene. Examples of suitable materials utilized to form conformal coatings include, but are not limited to, one or more parylene materials, one or more acrylic materials, one or more epoxy materials, polyurethane, silicones, polyimides, fluoropolymers, etc.

In the event that a conformal coating includes a parylene material, a wide variety of different types, of parylene may be utilized as desired in various embodiments of the disclosure. In general, a parylene material is a poly(p-xylylene) polymer that may be formed from a suitable dimer (e.g., cyclophane dimers, etc.). Examples of parylene (with example Chemical Abstracts Service or “CAS” identifiers) include, but are not limited to, parylene N (e.g., CAS 25722-33-2 formed from dimer 1633-22-3), parylene C (e.g., CAS 9052-19-2 formed from dimer 10366-05-9, CAS 28804-46-8, etc.), parylene D (e.g., CAS 52261-45-7 formed from dimer 30501-29-2), parylene HT or parylene AF-4 (e.g., CAS 3345-29-7 formed from dimer 3345-29-7, etc.). parylene F (e.g., CAS 1785-64-4 formed from dimer 1785-64-4), parylene A, parylene AM, parylene H, parylene SR, parylene HR, parylene NR, parylene CF, and/or parylene SF.

In certain embodiments, an adhesion promoter may be utilized to facilitate bonding between a conformal coating and underlying insulation. A wide variety of suitable adhesion promoters may be utilized as desired. For example, an adhesion promoter may be based on a silane material having hydrolysable groups on one end of the molecules and reactive nonhydrolyzable groups on the other end of the molecules. The hydrolyzable groups may react with moisture to yield silanol groups, which in turn may react with or adsorb inorganic surfaces to enable strong bonds. The nonhydrolyzable groups may be compatible with resin formulations.

A conformal layer may be formed with a wide variety of suitable thicknesses. In various embodiments, a conformal layer may have a thickness as thin as approximately several hundred angstroms to as thick as approximately 75 μm. In certain embodiments, a conformal layer may be formed with a thickness between approximately one micron (1 μm) and approximately 40 μm. Further, the thickness of a conformal layer (or any other insulation layer) may refer to the thickness on one surface of a magnet wire 100. With a layer formed around a magnet wire 100, the total “build” of the layer will be approximately two times that of the thickness at a surface.

The magnet wires 100, 125 described above with reference to FIGS. 1A and 1B are provided by way of example only. A wide variety of alternatives could be made to the illustrated magnet wires 100, 125 as desired in various embodiments. For example, a wide variety of different types of insulation layers maybe incorporated into a magnet wire 100, 125 in addition to a plurality of enamel layers and/or an extruded layer. As another example, the cross-sectional shape of a magnet wire 100, 125 and/or one or more insulation layers may be altered. Indeed, the present disclosure envisions a wide variety of suitable magnet wire constructions. These constructions may include insulation systems with any number of layers and/or sublayers.

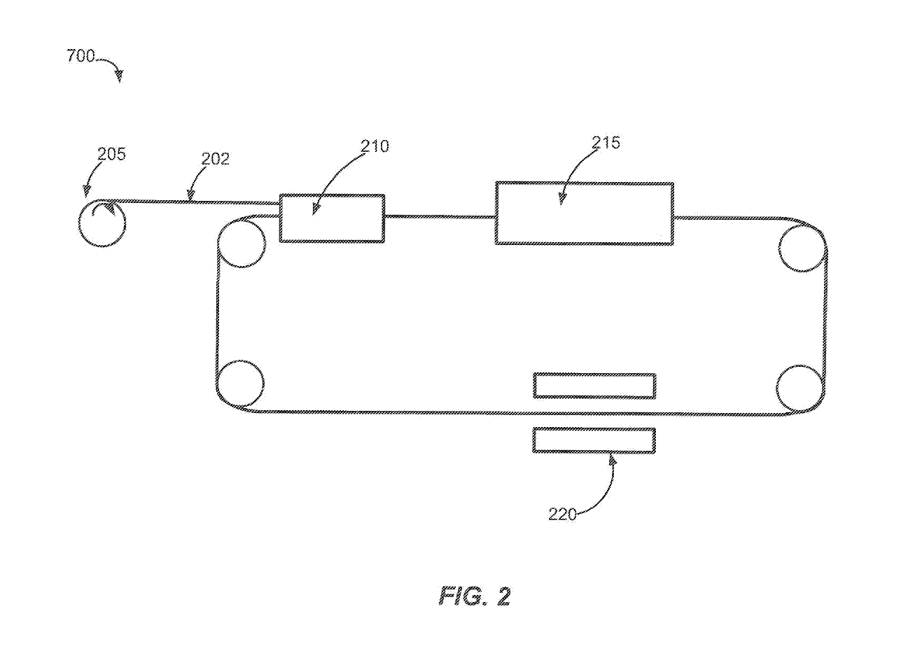

FIG. 2 illustrates a schematic diagram of an example system 200 that maybe utilized to form magnet wire in accordance with various embodiments of the disclosure. A conductor or bare magnet wire 202 may be provided to the system 200 from a suitable source 205. In certain embodiments, the wire 202 may be provided from a spool, reel, or similar source. In other words the wire 202 may be drawn or shaped in an offline manner and then stored for subsequent processing by the system 200. In other embodiments, the wire maybe provided to the system 200 from a prior system, subsystem, device, or component that facilitates formation of the wire 202. For example, the wire 202 may he provided in an inline or continuous manner from a suitable drawing machine, conform or extrusion system, or similar system that facilitates shaping or formation of the wire 202.

The wire 202 may be provided to a suitable varnish application system 210. The varnish application system 210 may apply an enamel varnish to an outer surface of the wire 202. The varnish may include, for example, polymeric material blended, suspended, or otherwise combined with one or more suitable solvents. As set forth above, a wide variety of different types of polymeric material may be utilized as desired, such as polyimide, polyamideimide, or other suitable materials. Additionally, a wide variety of different types of varnish application systems and/or devices may be utilized as desired. For example, one or more suitable dies may be utilized to apply varnish. In other embodiments, one or more brushes, rollers, or other suitable application devices may be utilized.

Once varnish has been applied to the wire 202, the wire 202 may be passed through one or more suitable enameling ovens 215 (or other suitable curing systems, components, or devices). The enameling oven(s) 215 may heat the wire 202 and applied varnish in order to cure the varnish and form an enamel layer. During the curing, solvents may be evaporated and a relatively solid polymeric enamel film layer may be formed on the wire 202. A wide variety of suitable enameling oven(s) 215 may be utilized as desired in various embodiments, such as horizontal ovens, vertical ovens, gas ovens, electric ovens, or other suitable ovens. In other embodiments, other types of curing systems, methods, and/or techniques may be utilized as an alternative to or in addition to enameling oven(s) 215. For example, infrared light curing systems, ultraviolet light curing systems, or other suitable curing systems may be utilized. Additionally, in certain embodiments, the wire 202 may be passed through a single oven or curing system. In other embodiments, the wire 202 may be passed through a plurality of ovens or curing systems.

Once the wire 202 with the formed enamel layer exits the oven(s) 215, the wire 202 may be processed by one or more suitable plasma, corona, UV, gas flame and/or other devices 220 configured to modify a surface of the formed enamel layer. A wide variety of suitable surface treatment devices 220 may be utilized as desired in various embodiments, such as one or more plasma units or plasma flame generation devices (e.g., plasma torch, etc.). Additionally, any number of surface treatment devices 220 may be utilized as desired. In an example system utilizing plasma treatment, a plasma device 220 may be utilized to bombard an outer surface of an enamel layer (or conductor if plasma devices are utilized prior to the formation of a first enamel layer as discussed in greater detail above) with plasma. Plasma may be an ionized gas capable of conducting electricity and absorbing energy from an electrical supply. In certain embodiments, a plasma gas may be produced by inducing an electrical charge in a suitable gas, such as oxygen, nitrogen, helium, ammonia, or argon. When plasma is utilized to modify an outer surface of an enamel layer, the plasma may alter the topography of the surface and/or impart roughness on the surface. In certain embodiments, the plasma may also functionalize the surface by causing the formation of one or more functional groups on the surface. The treatment may also alter a surface energy of the surface. Other suitable devices may be incorporated into the system 200 as desired in order to perform other suitable surface modifications, such as corona discharge devices, UV irradiation apparatuses, gas flame devices, etc. Plasma devices are described by way of non-limiting example only.

Following the treatment of the enamel layer by the surface treatment device(s) 220, the wire 202 may be provided to the varnish application system 210 for application of varnish for formation of a next or subsequent enamel layer. The wire 202 may then be passed through the enameling ovens 215 and the next enamel layer may be cured. The modified surface of the previously formed enamel layer may enhance bonding between adjacent enamel layers, therein limiting or reducing interlay delamination or separation. Additionally, the modified surface and/or modified surface energy may improve the wet lability of the varnish utilized to form the next enamel layer. In certain embodiments, the concentricity of the next enamel layer may be reduced or otherwise enhanced. The process of passing the wire through the system 200 may be repeated until a desired enamel build and/or thickness has been obtained.

Although not illustrated in the flow of FIG. 2, the wire 202 may optionally be treated by one or more surface treatment device(s) 220 prior to the formation of an innermost enamel layer. For example, the wire 202 may be provided from a source 205 and treated by the surface treatment device(s) 220 prior to application of the varnish used to form the first enamel layer. Additionally, the system 200 illustrates a single varnish application system 210, oven 215, and surface treatment device 220. In other embodiments, a plurality of any number of suitable devices may be utilized. For example, different application systems and ovens may be utilized to form successive enamel layers.

Additionally, when a desired enamel build has been obtained, in certain embodiments, the wire 202 may be taken up or spooled for distribution or subsequent processing. In other embodiments, the wire 202 may be provided to any number of suitable downstream devices or systems. For example, the wire 202 may be provided to one or more suitable extrusion devices that facilitate the formation of an extruded thermoplastic layer over the plurality of enamel layers. As another example, the wire 202 may be provided to one or more cutting and/or shaping systems that facilitate the formation of hairpins or other shaped articles from the wire 202. Indeed, a wide variety of suitable downstream systems may be utilized in conjunction with the system 200 of FIG. 2. In certain embodiments, the system 200 and a downstream system may process the wire 202 in a continuous or inline manner.

The system 200 described above with reference to FIG. 2 is provided by way of example only. A wide variety of alternatives could be made to the system 200 as desired in various embodiments. Further, a wide variety of additional components may be incorporated into the system 200 as desired. For example, the system 200 may include any number of pressure rollers, dancers, capstans, motors and/or other suitable devices that facilitate pulling and/or guiding the wire 202 between the various system components. As desired, the system 200 may also include any number of controllers or control devices, such as computers, microcontrollers, application specific circuit interfaces, programmable logic arrays, or other control devices that facilitate synchronization and/or configuration of any number of suitable system components. Indeed, the present disclosure envisions a wide variety of suitable systems that may be utilized to form magnet wire insulation.

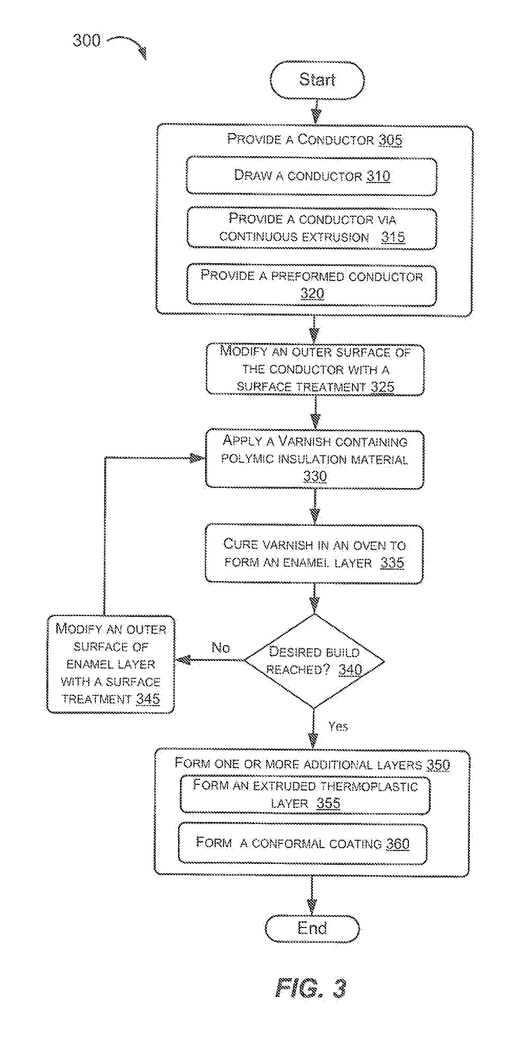

FIG. 3 illustrates a flow chart of an example method 300 for forming magnet wire in accordance with an illustrative embodiment of the disclosure. The method 300 may begin at block 305. At block 305, a magnet wire conductor may be provided in accordance with a wide variety of suitable techniques and/or utilizing a wide variety of suitable wire formation systems. For example, at block 310, a conductor may be drawn from a suitable input material (e.g., a larger diameter conductor, rod stock, etc.). In certain embodiments, a wire forming device may include one or more dies through which the input material is drawn in order to reduce the size of the input material to desired dimensions. Additionally, in certain embodiments, one or more flatteners arid/or rollers may be used to modify the cross-sectional shape of the input material before and/or after drawing the input material through any of the dies. For example, rollers may be used to flatten one or more-sides of input material in order to form a rectangular or square wire. In other embodiments, at block 315, a conductor may be provided via a suitable continuous extrusion or conform machine. For example, a conform machine may receive rod stock (or other suitable input material) from a payoff or other source, and the conform machine may process and/or manipulate the rod stock to produce a desired conductor via extrusion. As another example, at block 320, a preformed conductor may be provided or received from a suitable payoff or source. In other words, a conductor may be preformed in an offline process or obtained from a supplier.

At block 325, which may be optional in certain embodiments, an outer surface of the conductor may be modified by a plasma, corona, UV, flame, or other suitable treatment. For example, the conductor may be processed by one or more suitable plasma units and/or other devices that modify the outer surface. The surface treatment may clean the conductor and/or remove debris on the conductor, such as debris formed in a conductor drawing process. Additionally, the surface treatment may alter a topography of the conductor surface and/or form one or more functional groups on the conductor surface. The altered topography and/or functional groups may facilitate enhanced or improved bonding between the conductor and an enamel layer formed on the conductor. The altered topography may also modify the surface energy of the conductor, thereby improving the wettability of a varnish used to form an enamel layer on the conductor.

At block 330, a varnish containing polymeric insulation material may be applied. A wide variety of suitable methods and/or techniques may be utilized, to apply a varnish, such as one or more dies, brushes, etc. The varnish may then be cured in a suitable enameling oven at block 335 in order to form an enamel layer. During the curing, solvents in the varnish may be evaporated, and a relatively solid polymeric enamel layer may be formed. As set forth in greater detail above with reference to FIGS. 1A and 1B, an enamel layer may be formed from a wide variety of suitable materials, such as polyimide or polyimideamide.

At block 340, a determination may be made as to whether a desired enamel build and/or thickness has been reached. If it is determined at block 340 that a desired enamel build has not yet been reached, then operations may continue at block 345. At block 345, an outer surface of the previously formed enamel layer may be modified by a plasma, corona, UV, flame, or other suitable treatment. For example, the wire with the formed enamel layer may be processed by one or more suitable plasma units and/or other devices that modify the outer surface of the enamel layer. The surface treatment may clean the enamel layer and/or remove debris on the enamel layer. Additionally, the surface treatment may alter a topography of the enamel layer and/or form one or more functional groups on the surface of the enamel layer. The altered topography and/or functional groups may facilitate enhanced or improved bonding between the enamel layer and a subsequently formed layer, such as a subsequently formed enamel layer. The surface treatment may also modify a surface energy of the treated enamel layer, thereby improving the wettability of a varnish used to form a subsequent enamel layer. Operations may then continue at block 330, and an additional enamel layer may be formed. The process may be repeated as desired in order to attain a desired enamel thickness and/or build.

If it is determined at block 340 that a desired enamel build has been reached or achieved, then operations may continue at block 350. At block 350, which may be optional in certain embodiments, one or more additional layers may be formed around a plurality of enamel layers. As desired, an outermost enamel layer may have its outer surface modified by a suitable treatment as described in block 345 prior to the formation of an additional layer. Further, a wide variety of different types of additional layers as desired in various embodiments. For example, at block 355, one or more layers of extruded thermoplastic material may be formed around the conductor. Any number of suitable devices maybe configured to form an extruded layer, such as any number of suitable extrusion heads and/or other devices configured to apply a desired amount of thermoplastic insulation. As another example, one or more conformal coatings, such as one or more parylene-containing layers, may be formed at block 360. Any number of suitable devices may be configured to form a conformal layer, such as a suitable chemical vapor deposition chamber. The method may end following block 360.

The operations described and shown in the method 300 of FIG. 3 may be carried out or performed in any suitable order as desired in various embodiments. Additionally, in certain embodiments, at least a portion of the operations may be carried out in parallel. Furthermore, in certain embodiments, less than or more than the operations described in FIG. 3 may be performed.

Conditional language, such as, among others, “can,” “could,” “might,” or “may,” unless specifically stated otherwise, or otherwise, understood within the context as used, is generally intended to convey that certain embodiments could include, while other embodiments do not include, certain features, elements, and/or operations. Thus, such conditional language is not generally intended to imply that features, elements, and/or operations are in any way required for one or more embodiments or that one or more embodiments necessarily include logic for deciding, with or without user input or prompting, whether these features, elements, and/or operations are included or are to be performed in any particular embodiment.

Many modifications and other embodiments of the disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for forming an insulated winding wire, the method comprising:
providing a conductor:
forming a first enamel layer around the conductor, the first enamel layer comprising a first thermoset polymeric material;
modifying an outer surface of the first enamel layer via at least one of a plasma, corona, ultraviolet, or flame treatment; and
forming a second enamel layer on the first enamel layer, the second enamel layer comprising a second, thermoset polymeric material.

2. The method of claim 1, wherein modifying an outer surface of the first enamel layer promotes adhesion between the first enamel layer and the second enamel layer.

3. The method of claim 1, wherein modifying an outer surface of the first enamel layer comprises increasing a surface energy of the first enamel layer by approximately 20 to approximately 75 mN/m.

4. The method of claim 1, wherein modifying the outer surface of the first enamel layer comprises forming one or more functional groups on the outer surface.

5. The method of claim 1, wherein forming a first enamel layer comprises applying a first varnish, comprising the first thermoset polymeric material and curing the first varnish, and
wherein forming a second enamel layer comprises applying a second varnish comprising the second thermoset polymeric material and curing the second varnish.

6. The method of claim 1, wherein, at least one of forming a first enamel layer comprising a first thermoset polymeric material or forming a second enamel layer comprising a second thermoset polymeric material comprises forming a layer comprising polyimide.

7. The method of claim 1, wherein, at least one of forming a first enamel layer comprising a first thermoset polymeric material or forming a second enamel layer comprising a second thermoset polymeric material comprises forming a layer comprising one of polyimide, polyamideimide, amideimide, polyester, polyesterimide, polysulfone, polyphenylenesulfone, polysulfide, polyphenylenesulfide, polyetherimide, or polyamide.

8. The method of claim 1, further comprising:
modifying an outer surface of the conductor via a plasma, corona, or flame treatment prior to forming the first enamel layer.

9. The method of claim 1, further comprising:
modifying an outer surface of the second enamel layer via at least one of a plasma, corona, ultraviolet, or flame treatment; and
forming a third enamel layer on the second enamel layer, the third enamel layer comprising a third thermoset polymeric material.

10. The method of claim 1, further comprising forming an extruded thermoplastic layer around the second enamel layer.

11. A method for forming an insulated winding wire, the method comprising:
providing a conductor;
forming a first enamel, layer around the conductor, the first enamel layer comprising a first thermoset polymeric material;
treating an outer surface of the first enamel layer in order to increase a surface energy of the first enamel layer by approximately 20 to approximately 75 mN/m; and
forming a second enamel layer on the first enamel layer, the second enamel layer comprising a second thermoset polymeric material.

12. The method of claim 11, wherein treating an outer surface of the first enamel layer comprises treating an outer surface of the first enamel layer via at least one of a plasma, corona, ultraviolet, or flame treatment.

13. The method of claim 11, wherein, treating an outer surface of the first enamel layer further promotes adhesion between the first enamel layer and the second enamel layer.

14. The method of claim 11, wherein at least one of forming a first enamel layer comprising a first thermoset polymeric material or forming a second enamel layer comprising a second thermoset polymeric material comprises forming a layer comprising polyimide.

15. The method of claim 11, wherein at least one of forming a first enamel layer comprising a first thermoset polymeric material or forming a second enamel layer comprising a second thermoset polymeric material comprises forming a layer comprising one of polyimide, polyamideimide, amideimide, polyester, polyesterimide, polysulfone, polyphenylenesulfone, polysulfide, polyphenylenesulfide, polyetherimide, or polyamide.

16. A method tor forming an insulated winding wire, the method comprising:
providing a conductor;
forming a plurality of successive layers of enamel around the conductor, each of the plurality of layers of enamel comprising at least one thermoset material; and
modifying an outer surface of at least one of the plurality of layers of enamel prior to the formation of a next of the plurality of layers of enamel on the modified outer surface.

17. The method of claim 16, wherein modifying an outer surface of at least one of the plurality of layers of enamel comprises modifying an outer surface via at least one of a plasma, corona, ultraviolet, or flame treatment.

18. The method of claim 16, wherein modifying an outer surface of at least one of the plurality of layers of enamel comprises increasing a surface energy of the at least one of the plurality of layers of enamel by approximately 20 to approximately 75 mN/m.

19. The method of claim 16, wherein forming a plurality of successive layers of enamel comprises forming a plurality of successive layers of enamel that each comprise polyimide.

20. The method of claim 16 wherein funning a plurality of successive layers of enamel comprises forming a plurality of successive layers of enamel that each comprise one of polyimide, polyamideimide, amideimide, polyester, polyesterimide, polysulfone, polyphenylenesulfone, polysulfide, polyphenylenesulfide polyethenmide, or polyamide.
